(19) United States
(12) Patent Application Publication
(10) Pub. No.: US 2018/0235374 A1
(43) Pub. Date: Aug. 23, 2018

(54) Orthopedic Cushioning System

(71) Applicant: William Steven Kroll, Houston, TX (US)

(72) Inventor: William Steven Kroll, Houston, TX (US)

(21) Appl. No.: 15/436,038

(22) Filed: Feb. 17, 2017

(51) Int. Cl. A47C 20/02; A61G 5/10; A47C 7/42; A47C 27/14; A47C 31/10

(52) U.S. Cl. CPC A47C 20/02; A61G 5/1091; A47C 31/105; A47C 27/146; A47C 7/425

(57) ABSTRACT

An orthopedic cushioning device and system which includes a base cushion(s) and a plurality of smaller, modular cushion elements that may be changeably attached and arranged without tools or mechanical control systems onto the base cushion(s) and onto other cushion elements to form a custom surface topography. This cushioning system is a fully portable, lightweight support solution for the comfort of all people and especially for those with special orthopedic requirements and other physical problems. The system is adaptable to a wide variety human body sizes, shapes and forms. It may be used as an overlay on existing human support systems like chairs, wheelchairs, beds and vehicle seating. User reconfigurable, it does not require any external or internal power sources. The cushion elements may be methodically arranged over time to affect change in the relationship between the bones and their related connecting tissues, tendons, cartilage and ligaments of the user.

### BACKGROUND OF THE INVENTION

Various types of cushioning systems have been designed for providing comfort and orthopedic support to the user. For example, people use cushioned surfaces when sleeping, resting, travelling, etc. Cushions of various designs are employed within human support systems such as in couches, chairs, beds, automobiles, aircraft and wheelchairs.

In an attempt to customize the seating, bedding or other human support systems many designers have looked towards adjustable pillows. We see an example of this in U.S. Pat. No. 8,276,227 as disclosed by Pileggi, wherein a second smaller pillow attached to a face of the main pillow by an attachment member that is of sufficient length and flexibility to allow the second pillow to be positioned in an infinite number of parallel and/or skewed orientations relative to the first pillow. While novel, such a design does not provide specialized orthopedic support.

Most cushions have one basic form or shape. Some seating systems employ devices providing adjustability for lumbar support and bolstering, though in general, these are limited in their adjustability and portability. We see such an example in U.S. Pat. No. 5,344,211 as disclosed by Adat et al.. Known cushioned surfaces are therefore limited in their ability to provide the full comfort and support desired in a wide range of circumstances.

For persons with scoliosis, as an example, the curvature in their spinal column is not addressed by conventional cushion adjustments. This is because most available cushions are adjustable in a symmetrical manner. Persons with curved spines require supportive cushioning systems which are both curvilinear and asymmetrical. Said requirements are fundamental so as to provide for both comfort and corrective actions.

This matter of accommodating specialized cushions for persons with scoliosis and other orthopedic deformities and damages is not a new concept. Looking at U.S. Pat. No. 4,824,169 as disclosed by Jarrell with a wedge-shaped and a half-teardrop shaped cushion that drapes over a chair top and back. Said invention only accommodates the posture of the user with an offset of balance. It is highly linear in form and lacks curvature in its adjustability of the cushion form.

Solano, et al discloses a padded support cushion adapted for use with a chair or bed, especially a wheelchair in U.S. Pat. No. 5,056,533, the cushioning in this disclosure, though adjustable, does not address affecting complex orthopedic issues and offers only pad elements.

The complexity of orthopedic issues is addressed by Gowda as disclosed in U.S. Pat. No. 7,171,711 and also by Graebe in U.S. Pat. No. 5,561,875 with individually controlled air chambers. While these inventions address the cushion's ability to conform to the user's anatomy, they are both complex and require external power and controllers for their function which limits their application to a broad segment and lessens their portability.

Persons with various forms of paralysis caused by nerve injury, poliomyelitis, cerebral palsy, peripheral neuropathy, Parkinson's disease, ALS, Botulism, Spina Bifida, amputation, Multiple Sclerosis and Guillain-Barré syndrome require special cushioning surfaces to address their specific needs. Seldom is the required asymmetrical support provided for in typical cushioned furniture, seating or bedding. As we examine the disclosure of Saro, et al. U.S. Pat. No. 5,448,790, which specifically aims at a specialized and adjustable cushion system for people with neuro-muscular damage, we see disclosed movable cushion parts whose symmetrical parts are not re-combinable or additive in nature, which limits their scope of adaptability.

Accordingly, it is desirable to provide a cushioning system that is capable of infinite topographical variations. My new system is light in weight, portable and flexible in nature so that it may overlay an existing cushioning on various types of human support surfaces and devices while providing modular cushions which can recombine into 3-D forms that can provide most any desired form or shape. This new and novel design is suited for the ergonomic and orthopedic support of the user with a tool-free rearrangement of its cushioning elements. Such support, comfort, portability and versatility is lacking in currently known cushioning systems and devices.

### BRIEF SUMMARY OF THE INVENTION

My Orthopedic Cushioning System provides a customizable, economical, lightweight and highly portable cushioning system. It has modular cushion elements can be arranged, combined and re-combined onto a base cushion to form a human support system that is fully customizable to suit the user's anatomy and their orthopedic requirements.

Previous cushioning systems have been designed with mechanical devices as a manner of adjusting the form of the human support system to the needs of the user. Some have elaborate frameworks, mechanisms, electronic controllers, fluid pumps, motors and switches which adds not only to the expense of complexity of those devices and systems but also limits their range of utilization as to their power requirements, adaptability, portability and cost to the user. My new cushioning system obviates the need for those complications as seen in previous disclosures.

In its preferred embodiment, the base cushions of the system are light in weight, firm, flexible and resilient so that the system may better conform to a pre-existing human support system, as a means of providing a stable surface onto which the modular cushion elements are placed and, in the preferred embodiment, providing a very portable system which can be used on a wide range of human seating systems. This new cushioning system provides comfort and orthopedic benefits to the user without the need for external power sources, metals or hard objects in its use.

In the preferred embodiment of this cushioning system, the primary parts may be upholstered with loop style material, as in reference to that said portion of “hook and loop” fastening systems. At strategic points on the base cushion(s) and the modular cushion elements, there may be provisioned hook style material as a way of fastening to those parts which have loop style materials. The combination of materials utilized, provides for a cushioning system that, once configured for the user's wants and needs, is stable and rearrangeable in its customized 3-D form.

My new Orthopedic Cushioning System is portable and adaptable for use with reclining and upright chair designs as well as wheelchairs, automobile and airline seats, beds and any other manner of existing human support system.

### A BRIEF DESCRIPTION OF THE DRAWINGS

FIG. 1 is an isometric view of the cushioning system as it might be configured for a user in the supine position.

FIG. 2. is an isometric view of a cross-section of the base cushion material's construction.

FIG. 3. is a detailed view of the repositionable cushion elements used to create virtually unlimited topographical surfaces upon the base cushions utilized by the user.

FIG. 4. is a top view of the cushion system as installed upon an existing human support system.

FIG. 5. is an perspective view of the invention in use.

FIG. 6. is a side view of the invention in use.

FIG. 7 is an isometric view of base cushion 1 with cushion elements used in an office chair.

### A DETAILED DESCRIPTION OF THE DRAWINGS

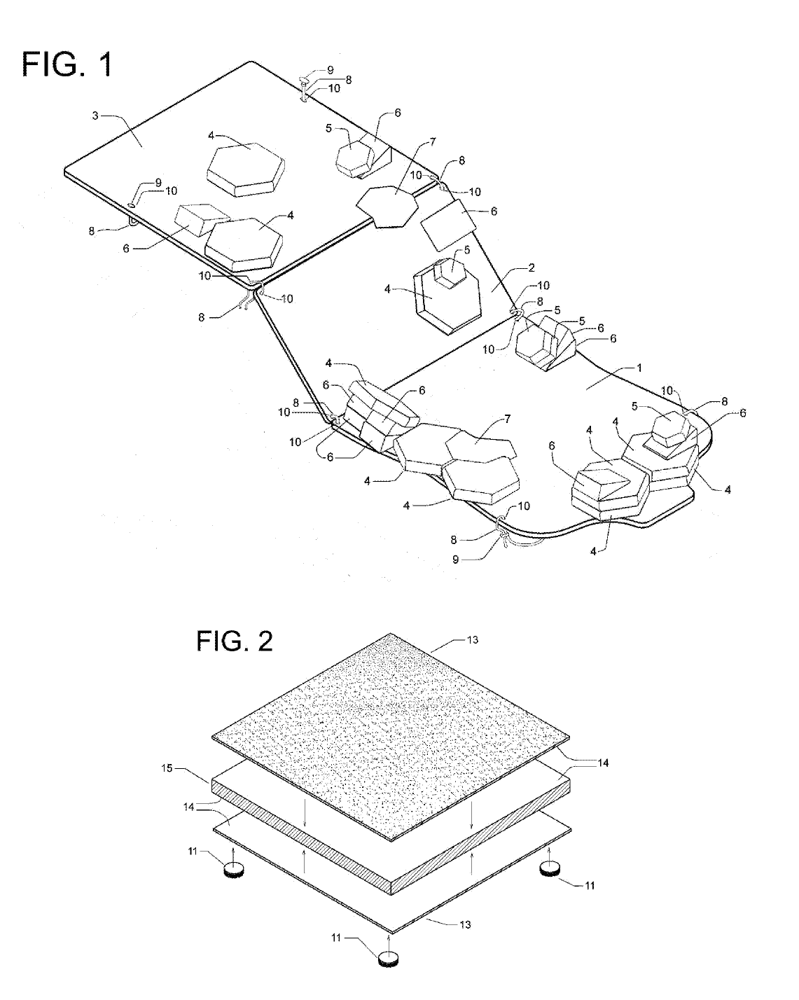

FIG. 1 is an isometric view of the cushioning system as it might be configured for a user in the supine position. There are three primary base cushion sections being used in this configuration of the cushioning system that are labeled as 1, 2 and 3. All or any desired combination of these base cushion elements may be utilized by the user, as befits their needs, and the shapes and sizes of these base elements is an option for both the user's preference as well as the existing human support system upon which it is being placed. Base cushion 1., in this arrangement, is being used as an area that has been optimized to support the head and torso of the user. The head in this arrangement, would be located nearest the viewer and is supported with a user configurable placement and positioning of the cushion elements labeled 4, 5 and wedge cushion element 6. Also upon base cushion 1 as located progressively further from the viewer, you will see that lateral support is provided to the user's rib cage utilizing cushion forms 4 and the edges of those cushioning elements is softened with the overlay of cushion element 7 which is temporarily secured two the cushions bearing label 4 as well as to the surface of base cushion 1. This type, or a similar grouping of positioning and/or a combination of cushioning elements may also provide some measure of twist to the user's torso. Still further from the viewer, upon base cushion 1, we see two separate groupings composed of cushion elements 4, 5 and wedge elements 6. In these two arrangements, located nearer the outer edges of said base cushion 1 the hips are bolstered on the user's left side to a greater degree and extent than the grouping on the user's right side. In this optional arrangement, this twist imparted by the previously described grouping is reinforced by said group of cushioning elements. Moving further away from the viewer to base cushion section 2 you will notice the more centrally positioned grouping of cushion elements 4 and 5. The location of this cushion element group would coincide with the user's right gluteus maximus, in this arrangement, and may be used to elevate same. Said optional and reconfigurable arrangement and position, in this instance may act as a subtle means of counteracting, and thus protracting, the torso twist imparted by the cushioning elements that were previously described as being located upon base cushion 1.

Progressing further from the viewer's perspective, we see wedge cushioning element 6 located near the edge of base cushion 2 nearest the far-right edge of the aforesaid base cushion. This might be of use in assisting to locate the outermost boundary of the user's right thigh whilst lying on the cushioning system in a supine position. And still further we see cushion element 7 which is temporarily and optionally attached to both base cushion two as well as base cushion 3. In this location, and optionally elsewhere, the cushion element is being used to both connect and soften the relationship of base cushions 2 and 3 and further to subrogate the requirement of cordage element 8 as a means of connecting base sections together. The cordage element labeled as 8 in the drawing, may have the nature of high or low stretch properties, depending upon its utilization in the cushioning system. It can be fitted with an end stopper, as labeled 9. in the drawing to prevent it from passing through holes labeled as 10 upon any of the base cushion sections. Through-holes may be used throughout the cushioning system to attach base cushions together when combined with cordage 8 with or without the use of a stopper 9. Said through holes with the label 10 may also be used throughout and and/or all the base cushions as a means of ventilation and as a means of affording cordage or other means to attach the cushioning system upon another existing human support system. The furthermost base cushion from the viewer is base cushion 3. For this segment of the cushioning system we see cushion elements 4, 5 and 6 being used to assist in maintaining a user desired leg(s) position.

FIG. 2 is an isometric cross section view of the base cushion material's construction. The outer layer 13 is a loop style fabric, commonly referred to under the trade name of Veltex. This fabric 13 may be substantially bonded 14, to the core material 15. Said bonding may be achieved through chemical bonding agents, such as acrylic polymers or via mechanical methods such as sewing or other. Veltex style fabric 13 may also be optionally applied to the opposite side of the foam core 15. Use of the Veltex fabric 13 for the underside of the base cushion allows attachment of the assorted available cushion elements such as those labeled 5, 6 and 7. The core 15 may be of a flexible, tough and compliant material which would have the desirous qualities like those of cross-linked polyethylene foam material, though other materials may be utilized. The underside of the construction may also be fitted with portions of hooked material 11, commonly referenced as the commercial product Velcro, this being the hooked material portion of a fastening system generically referred to as a hook and loop fastener system which may be used to position the base cushion upon an existing human support system in addition to or in lieu of binding with cordage 8.

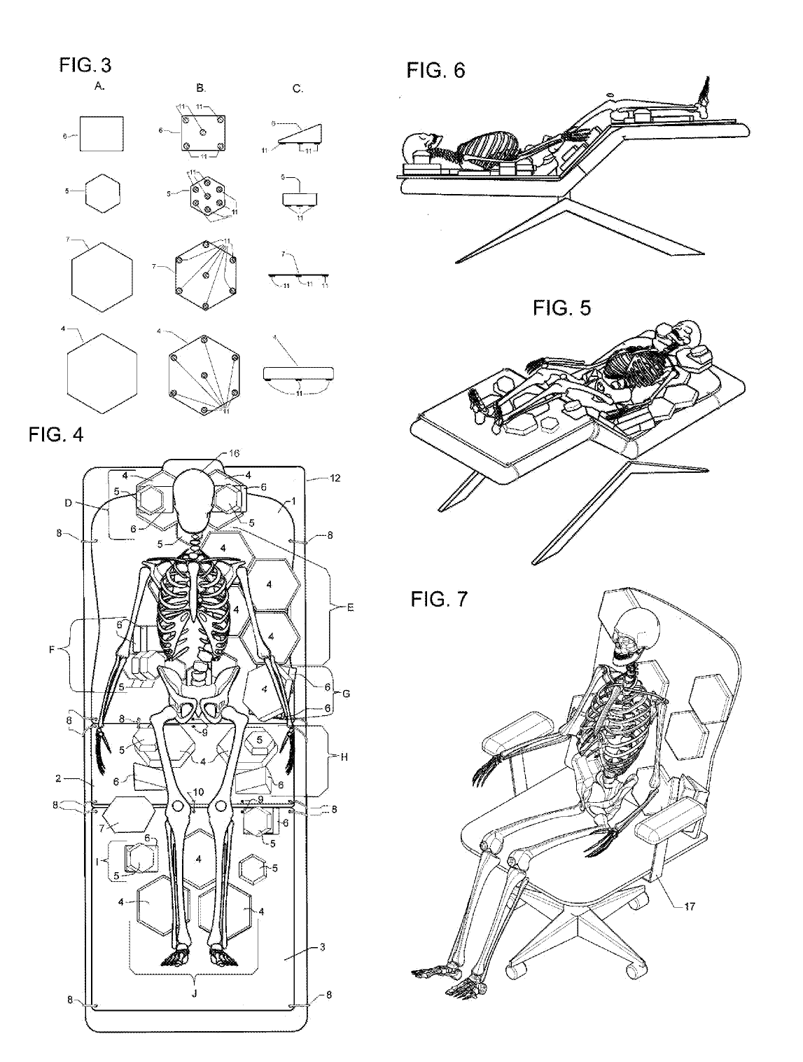

FIG. 3 is a detailed view of the repositionable cushion elements used to create virtually unlimited topographical surfaces upon the base cushions utilized by the user. Though the cushions numbered 4, 5 and 7 are each essentially flat in shape, they may be formed or shaped with an overall sphericity or curvature of the top surface. The outer boundary edges of the cushion elements are not required to have a hexagonal form. The overall shape of a hexagon was used in these drawings for aesthetic purposes as well as for its inherent geometric efficiency. The cushion elements may be of virtually any outline geometric shape or combination of shapes. Wedge cushion element 6, the wedge angle shape need not be a specific degree of incline. In the preferred embodiment, a standard of 22-½ degrees of angular slope would serve the purposes well, however, a particularly specified angle is not required for functionality. All wedges should, in the preferred embodiment, have the same size, shape and inclination of form so that they may serve their use as modular components within the same cushioning system. There may be, however, different scale sizes of cushioning systems to serve different sizes of user or for an existing human support system for which they are intended. Labels A, B and C in this drawing represent the vertical columns related to the particular view of each of the various the cushion elements depicted. Column A is a top view, B is a bottom view and C is a side view. Opposite sides of these cushion elements are mirror views. In the preferred embodiment of the cushion elements, each is covered on all sides and or surfaces with a loop type fabric. Said fabric loop material may be substantially bonded to the core of the cushion. On at least one side of each cushion element, a corresponding fastening element of hook material may be attached onto the loop material which encases the foam core. The foam cores of the elements are preferred to be of an open cell structure to facilitate air flow to the user, however, this does not preclude the use of closed cell foam materials or a combination of materials. As is the case of the wedge cushion element 6 it is often used as a base for the other cushions and may be of a closed foam material which may have a higher density of foam than the flat cushions 4, 5 and 7.

FIG. 4 is a top view of the cushion system as installed upon an existing human support system 12 in the drawing. The human user 16 in this drawing is represented by a human skeleton 16. This drawing illustrates the potential cause and effect relationships between the invention, a user adjustable cushioning system and a human skeletal structure 16 afflicted with idiopathic scoliosis. This drawing shows the various cushioning elements, as labeled and shown in FIG. 3 and which are labeled as 4 through 7 and subsequently marked with external bracket markings as cushion element groups D, E, F, G, H, I and J. These user rearrangeable cushion element groups are arranged and positioned by or for the user to provide the perception of comfort to the user as well as to affect a positive change in the overall vertical alignment of the spine. Group D, located on base cushion 1, is a user arranged support for the skull and vertebrae of the neck and controls the elevation as well as X, Y and Z-Axis movements of same. Group E, located on base cushion 1, provides additional cushion to the user's left side back and shoulder in this arrangement. Because it is arranged in an asymmetrical manner, underlying only half of the torso the elevation difference along the medial line imparts a minor twist to the spine. Group F, located on base cushion 1, forms a bolster which supports lateral movement of the user's right torso including that side of the rib cage and the right hip. Group G, located on base cushion 1, forms a bolster that effects position of the user's left hip. Group H, located on base cushion 2, provides additional cushioning and positioning for the user's hips, legs and gluteus maximus on the user's left and right sides. Group I, located on base cushion 3, controls lateral leg positioning for the user's left and right sides. Group J, located on base cushion 3, is being used as an elevation enhancement for the user's calves and feet.

FIG. 5 is a perspective view of the invention in use.

FIG. 6 is a side view of the invention in use.

FIG. 7 is an isometric view of the invention when utilizing only one base cushion section 1 with modular cushion elements in an office style chair 17.

I claim:

1. A cushioning system comprised of a generally rectangular shaped and substantially flat base cushion member which is composed of material or a composite of materials which enable the base cushion member to conform to an existing human support system onto which it is overlaid and having a resilient nature that enables it to resume to its original and substantially flat form after use, with a primary surface face substantially covered in a loop-type material which is adhered to said surface and the opposite side of the afore-mentioned primary surface may be augmented with anti-skid materials and/or devices for securing said flexible base member to an existing human support system and a plurality of modular cushions, which are of generally flat and wedge forms, with each having at least one primary face having a loop-type material which may be substantially or fully adhered to its surface and having an opposing face which may be equipped with hook style fasteners which may be rearrangably attached to the base cushion member(s), as well as to other cushion elements, by the user or by an orthopedic practitioner to create an infinite variety of topographical features which are for the benefit of the user's comfort and orthopedic needs and requirements.

2. A cushioning system as defined in claim 1 wherein the system may be utilized in a systematic manner which may affect and modify the relationship between the vertebra of the user's spinal column.

3. A cushioning system as defined in claim 2 wherein the system's arrangement of cushions may be modified by rearrangement of the cushion elements over a prescribed course of placement and a determined duration of time.

4. A cushioning system as defined in claim 3 wherein the system's arrangement of cushions is determined by an orthopedic or chiropractic professional for the benefit of the user.

5. A cushioning system as defined in claim 4 wherein the system's arrangement of cushion elements upon the base cushion member(s) over a prescribed course of placement and time, is designed to alter the shape of the user's spinal column.

6. A cushioning system as defined in claim 5 wherein the system's arrangement of cushion elements, over a prescribed course of rearrangement and time, is designed to modify the user's pelvis and rib cage anatomical relationship.

7. A cushioning system as defined in claim 6 wherein the system's arrangement of cushion elements upon the base cushion member(s), over a prescribed course of arrangement and time, is designed to alter the center of gravity of the user's skeletal-muscular anatomy when the user is no longer in a supine, semi-supine or reclining position.

8. A cushioning system as defined in claim 7 wherein the base member cushion(s) may be composed of a singular mass of polyethylene foam or cross-linked polyethylene foam or a composite material with desirable characteristics which may be of to various forms of foams or of materials with a similar nature of resilience and tear strength.

9. A cushioning system as defined in claim 8 wherein the base cushion member(s) may be composed of multiple layers of polyethylene, polyurethane or viscoelastic foam or of materials with desirable characteristics which may be used together to form a mass.

10. A cushioning system as defined in claim 9 wherein the base cushion member(s) may contain negative spaces which afford additional flexibility to the base member.

11. A cushioning system as defined in claim 10 wherein the base cushion member(s) may contain negative spaces which enhances air movement through the base.

12. A cushioning system as defined in claim 11 wherein negative spaces in the base cushion member(s) may be used as attachment points.

13. A cushioning system as defined in claim 12 wherein the base member cushion(s) shape may be designed in accordance with or configured for use on specific designs of existing human support systems.

14. A cushioning system as defined in claim 13 wherein the base cushion member(s) may be composed of a multiplicity of sections which enables it to more fully conform to the design of existing human support systems.

15. A cushioning system as defined in claim 14 wherein the multiplicity of sections which compose the base cushion member, may be permanently or rearrangably attached to one another.

16. A cushioning system as defined in claim 15 wherein the base cushion member(s) may be deployed upon a custom human support system.

17. A cushioning system as defined in claim 16 wherein the base cushion member(s) may be utilized without the benefit of an existing human support system.

18. A cushioning system as defined in claim 17 wherein the base cushion member(s) is radiolucent.

19. A cushioning system as defined in claim 18 wherein the modular cushions may be composed a singular mass of polyethylene, polyurethane or viscoelastic foam or of materials with similar characteristics.

20. A cushioning system as defined in claim 19 wherein the modular cushions may be composed of a multiplicity of layers of polyethylene, polyurethane or viscoelastic foam or of materials with desirable characteristics which may be bonded or formed together to form a singular mass.

21. A cushioning system as defined in claim 20 wherein the modular cushions elements may contain negative spaces which enhance air flow through the modular cushion elements.
